(19) United States
(12) Patent Application Publication
(10) Pub. No.: US 2023/0050608 A1
(43) Pub. Date: Feb. 16, 2023

(54) APPARATUS AND METHOD FOR TRANSMITTING UPLINK SIGNALS ACCORDING TO DIFFERENT TRANSMISSION CONFIGURATIONS FOR SPATIAL SETTINGS

(71) Applicant: MEDIATEK INC., Hsin-Chu (TW)

(72) Inventor: Lung-Sheng Tsai, Hsinchu City (TW)

(73) Assignee: MEDIATEK INC., Hsin-Chu (TW)

(21) Appl. No.: 17/793,043

(22) PCT Filed: Jan. 15, 2021
(86) PCT No.: PCT/CN2021/072226

§ 371 Date: Jul. 15, 2022

Related U.S. Application Data
(60) Provisional application No. 62/962,293, filed on Jan. 17, 2020.

(51) Int. Cl. H04W 72/12

(52) U.S. Cl. CPC H04W 72/1284; H04W 72/1268

(57) ABSTRACT

A method includes: transmitting a plurality of data signals via a physical uplink shared channel (PUSCH) or a plurality of report signals via a physical uplink control channel (PUCCH) from a user equipment to a wireless network according to a plurality of transmission configurations for spatial settings; and receiving a control signal before the transmitting, by a user equipment, from the wireless network, wherein the control signal indicates the plurality of transmission configurations for the spatial settings; the plurality of transmission configurations for the spatial settings are associated with multiple reference signals.

### FIELD OF THE INVENTION

The invention relates to a mobile/cellular wireless communication system, and more particularly to an apparatus and method for transmitting uplink signals according to different transmission configurations for spatial settings.

### BACKGROUND

Generally speaking, a mobile device can change a beam direction to receive a signal transmitted from a base station or to transmit a signal to the base station in a communication system. However, since the location of the mobile device may be changed, the mobile device may use an inappropriate beam direction to transmit uplink signals. The efficiency and reliability of uplink data/control transmission may be poor in a conventional communication system.

### SUMMARY

Therefore one of the objectives of the invention is to provide an apparatus and corresponding method in a mobile/cellular wireless communication system, to solve the above-mentioned problems.

According to embodiments of the invention, a method is disclosed. The method comprises: transmitting, on a plurality of time-frequency resources, a plurality of data signals via a physical uplink shared channel (PUSCH) or a plurality of report signals via a physical uplink control channel (PUCCH) from a user equipment to a wireless network according to a plurality of transmission configurations for spatial settings; and receiving a control signal before the transmitting, by a user equipment, from the wireless network, wherein the control signal indicates the plurality of transmission configurations for the spatial settings. The plurality of transmission configurations for the spatial settings are associated with multiple reference signals.

According to the embodiments, an apparatus is disclosed. The apparatus comprises a transceiver and a processor. The transceiver is used for wirelessly communicating with one or more network nodes of a wireless network. The processor is coupled to the transceiver, and it is used for: controlling the transceiver transmitting, on a plurality of time-frequency resources, a plurality of data signals via a PUSCH or a plurality of report signals via a PUCCH from the apparatus to the wireless network according to a plurality of transmission configurations for spatial settings; and controlling the transceiver receiving a control signal from the wireless network before transmitting the plurality of data signals, wherein the control signal indicates the plurality of transmission configurations for the spatial settings. The plurality of transmission configurations for the spatial settings are associated with multiple reference signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an apparatus in a wireless communication system such as Fifth-Generation (5G) new radio (NR) mobile/cellular wireless communication system according to an embodiment of the invention.

FIG. 2 is a diagram showing a concept of a scenario example of uplink transmissions via PUSCH/PUCCH according to an embodiment of the invention.

### DETAILED DESCRIPTION

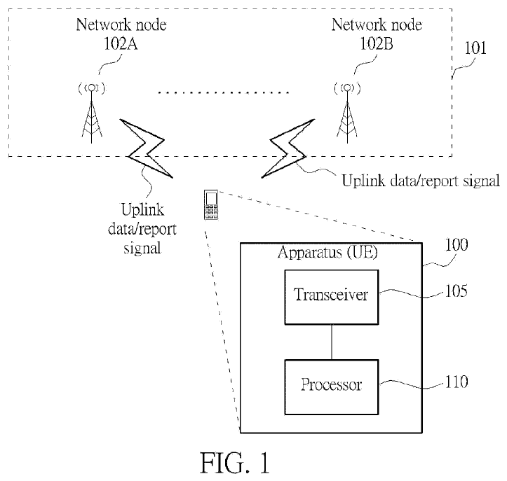

FIG. 1 is a block diagram of an apparatus 100 in a wireless communication system such as Fifth-Generation (5G) new radio (NR) mobile/cellular wireless communication system (but not limited) according to an embodiment of the invention. The wireless communication system may comprise one or more apparatuses 100 of user(s), i.e. user equipment (UE), and a wireless network 101 having one or more network nodes (or referred to as base stations) such as 102A and 102B. Each network node (or base station) 102A and 102B for example may be referred as to a Node B, an evolved Node B, or a transmission reception point (TRP) which means a base station point capable of transmitting/receiving signals. The UE 100 can be connected to the wireless network 101 through one or more TRPs.

The UE 100 comprises a transceiver 105 for transmitting/receiving uplink/downlink (UL/DL) signals and control/report signals and comprises a processor 110 for controlling the transceiver 105. The transceiver 105 is capable of and used for wirelessly communicating with more than one network nodes 102A and 102B of the wireless network 101 in the wireless communication system. The control/report signals for example may comprise or may be obtained from a set of acknowledgments or negative acknowledgments, channel state information (CSI) reports, or any combinations.

For uplink transmission for multiple-TRP reception, the transceiver 105 can be arranged to communicate with more than one network nodes 102A and 102B. For example, the transceiver 105 may transmit uplink data/signals to or may communicate with multiple network nodes 102A and 102B simultaneously at the same timing (or the same time slot); uplink data/signals for different network nodes 102A and 102B can be identical, duplicated, or can be different. That is, the uplink data (or data signals) can be obtained from the same raw data information. In this example, for simultaneous uplink transmission, the transceiver 105 may use different transmission configurations for different spatial settings (e.g. multiple different beams with different beam directions; but not limited) to transmit uplink data signals to the multiple network nodes 102A and 102B individually. Alternatively, in another example, the transceiver 105 may transmit data signals to or communicate with multiple network nodes 102A and 102B individually/separately at different timings (or different time slots) based on time-division multiplexing (TDM). This is not meant to be a limitation of the invention.

It should be noted that a data channel used for uplink transmission is for example a physical uplink shared channel (referred to as PUSCH), and a control channel used for uplink transmission is for example a physical uplink control channel (referred to as PUCCH). Uplink data/control signals are sent via PUSCH and PUCCH respectively in either the same time slot or different time slots.

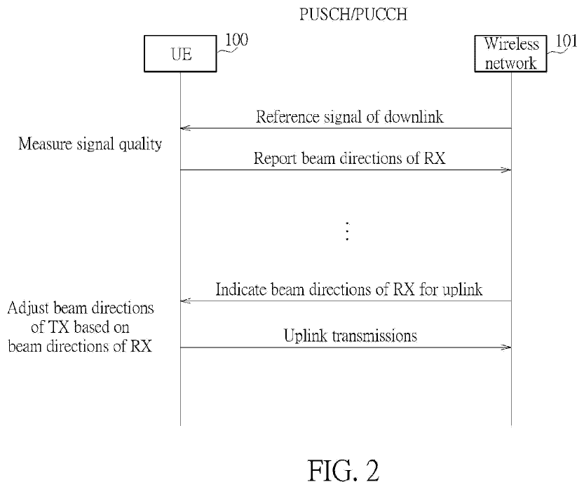

FIG. 2 shows a concept of a scenario example of uplink transmissions via PUSCH/PUCCH according to an embodiment of the invention. As shown in FIG. 2, in either way of PUSCH or PUCCH, the wireless network 101 is arranged to transmit reference signal(s) of downlink transmission to the UE 100. The UE 100 is arranged to measure the signal quality of the reference signal(s) and then report its preferred transmission beam directions, which may be implicitly associated with the measured reference signal(s), for signal reception (RX) back to the wireless network 101. It should be noted that many ways are possible to report its preferred beam directions either explicitly or implicitly. For example, an implicit way is to report which measured reference signal is preferred with the best signal strength. Meanwhile, the UE 100 also knows which beam can be used for later DL reception or UL transmission associated with each of the measured reference signals. Then, in uplink communication, the wireless network 101 is arranged to indicate or notify the UE 100 of the beam directions of RX for uplink communication, for example, by indicating an association with one or multiple of the measured reference signals. After receiving the indications, the UE 100 is arranged to adjust the beam directions of signal transmission (TX) based on the beam directions of RX to transmit uplink data/control/report signals to the wireless network 101.

In practice, the processor 110 controls the transceiver 105 transmitting a plurality of data signals via the PUSCH or a plurality of report signals via the PUCCH, on a plurality of time-frequency resources (allocated by PUSCH resources and PUCCH resources) from UE 100 to multiple network nodes 102A and 102B of the wireless network 101 according to the plurality of transmission configurations for the spatial settings which indicate different transmitting (TX) beams or different TX spatial filers. That is, in either way for PUSCH/PUCCH uplink transmission, the UE 100 is arranged to form more than one different TX beams which directs to more than one target network nodes 102A and 102B having the signal coverage range which the UE 100 is located in.

The transmission configurations for the spatial settings can be determined or selected according to a control signal transmitted from the wireless network 101 to UE 100. For instance, before transmitting the data signals or the report signals, the processor 110 controls the transceiver 105 receiving such control signal from one or more network nodes 102A and 102B of the wireless network 101 wherein the control signal, carrying content/information of different spatial settings, is used to indicate the transmission configurations for the spatial settings used in uplink transmission. That is, the transmission configurations for the spatial settings used in uplink transmission are determined by the wireless network 101.

The control signal for example may be obtained from downlink control information (DCI) data transmitted from the wireless network 101 to UE 100, and the control signal may indicate more than one TCI (Transmission Configuration Indicator) states, i.e. two or more sets of TX spatial filters/beams. That is, the wireless network 101 or at least network node 102A/102B sends the control signal to the UE 100 to suggest and indicate which transmission configurations of TX beams are good or better by using the control signal to indicate which sounding reference signal (SRS) resources are received with good/better signal qualities.

In one embodiment, the above-mentioned data signals such as uplink data signals via the PUSCH can be identical or different, and similarly the report signals via the PUCCH can be identical or different. That is, UE 100 can transmit duplicated/different data signals on time-frequency resources of PUSCH or duplicated/different report signals on time-frequency resources of PUCCH to multiple different network nodes 102A and 102B. In the 5G NR wireless communication system, transmitting duplicated data/report signals in uplink transmission to the different base stations based on different transmission configuration for different spatial settings can significantly improve the efficiency and reliability of signal reception.

The transmission configurations for spatial settings are associated with or selected based on multiple different reference signals which for example (but not limited) are downlink reference signals transmitted from the different network nodes 102A and 102B to UE 100 and are used for beam managements in downlink communications. The multiple reference signals as another example could be two or more SRS resources. For instance, before starting downlink communication from the wireless network 101 to the UE 100, one or each target network node 102A/102B is arranged to transmit a downlink reference signal to the UE 100 which is located within the signal coverage range of the one or each network node. For the UE 100, it may receive different downlink reference signals from different network nodes 102A and 102B. In this situation, the transceiver 105 sequentially adjusts its spatial setting (e.g. adjusting its receiving (RX) beam direction) to respectively use different spatial settings to receive the downlink reference signal transmitted from a corresponding network node 102A/102B and correspondingly measure its signal quality of the reception of the reference signal.

The transceiver 105 can correspondingly obtain/select a transmission configuration of a preferred spatial setting associated with a good/better/best signal quality. Thus, for the different network nodes 102A and 102B, the transceiver 105 can obtain transmission configurations of identical, different, or partially different preferred spatial settings of the different network nodes 102A and 102B for downlink communication. The processor 110 controls the transceiver 105 reporting measured signal qualities corresponding to the transmission configurations respectively to the different network nodes 102A and 102B. Then, for the reception of data/control/report signals at network nodes 102A and/or 102B for uplink transmission with uplink grant, the wireless network 101 is arranged to notify the UE 100 of using the transmission configurations of spatial settings used in downlink communication for uplink transmission. That is, the transmission configurations of spatial settings used in downlink communication, e.g. beam directions of RX, are also used as the transmission configurations of spatial settings in the uplink transmission, e.g. beam directions of TX, to transmit signals respectively to the network nodes 102A and 102B. This may be achieved by indicating one or multiple previous measured downlink reference signal(s) as reference signal(s) for deciding TX beam direction(s) of PUSCH/PUCCH transmission(s) in uplink, and may not be by explicit indication of which TX beam direction(s) should be applied. For example, the UE has known which RX beam can be used associated with each of previous measured reference signals, and it may apply the same RX beam or with slight adjustment according to the indicated downlink reference signal(s) as TX beam for uplink transmission.

When the transceiver 105 would like to communicate with one or more network nodes 102A and 102B via an uplink channel such as PUCCH or PUSCH, the wireless network 101 or at least one network node 102A/102B is arranged to transmit transmission configuration information to indicate, may be in an implied way, the preferred spatial settings (comprising the selected spatial filters or selected beam directions) used for uplink transmission and information of which time-frequency resource(s) is to be allocated or occupied by the UE 100 to the transceiver 105. The transmission configurations of the preferred spatial settings used in uplink transmission(s) between the UE 100 and multiple network nodes 102A and 102B are respectively determined or controlled/dominated by the multiple network nodes 102A or 102B or the wireless network 101.

For example, a network node 102A/102B may use a TCI state to determine or indicate the transmission configuration of a preferred spatial setting in uplink transmission between the UE 100 and network node 102A/102B wherein the TCI state is used to indicate which beam direction (or which reference signal to derive spatial filter) of the transceiver 105 should be or would be selected; however, this is not intended to be a limitation. The wireless network 101 is arranged to use multiple TCI states to indicate he transmission configurations of the preferred spatial settings in uplink transmissions between the UE 100 and different network nodes 102A and 102B.

In one embodiment, for example, a network node 102A/102B may determine the transmission configuration of a preferred spatial setting in uplink transmission between UE 100 and the network node 102A/102B by referring to an indication such as a sounding reference signal (SRS) indicator. The SRS indicator for example may be implemented by using an SRI (SRS Resource Indicator) field in the 5G NR wireless communication system; the SRI field is used to indicate which SRS resource(s), which TCI state(s), and/or which set(s) of spatial relation information is/are reference information for the uplink transmission. That is, the SRI field may indicate two or more SRS resources. However, this is not intended to be a limitation. The wireless network 101 or different network nodes 102A and 102B can determine the transmission configurations of preferred spatial settings in uplink transmissions for the UE 100 by referring to two or more than two SRS resources. Thus, the above-mentioned control signal received by the UE 100 from the wireless network 101 can indicate two or more than two different SRS resources. The UE 100 may need to know two Quasi-Co-Location (QCL) assumptions (for transmission toward two TRPs) via two SRS resources. A QCL assumption can be obtained via spatial relation info which is defined as follows:

| “SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}”.
```

The ‘refernceSignal’ field in SRS-SpatialRelationInfo is used to let UE know which reference signal should be used to derive its TX spatial filter for transmission of this SRS resource. Thus if the SRI field indicates two or more SRS resources, the UE can derive two or more TX beam directions towards the network node 102A/102B.

Further, the above-mentioned time-frequency resources corresponding to multiple PUSCHs or PUCCHs can be not overlapped in time domain or not overlapped in frequency domain. The time-frequency resources, used for transmitting the data signals or report signals, can be determined based on multiple channel resources or a single one channel resource. For example, the time-frequency resources of two PUSCHs, used for transmitting the data signals, can be individually provided or determined according to the time-frequency resource of one of the PUSCHs. Similarly, the time-frequency resources of two PUCCHs, used for transmitting the report signals, can be individually provided or determined according to the time-frequency resource of one of the PUCCHs.

Further, in one embodiment, the configuration of the spatial relation information is determined by the wireless network 101 or at least one network node 102A/102B by association with a downlink reference signal from the wireless network 101, i.e. a reference signal in downlink communication. In another embodiment, the configuration of the spatial relation information is determined by the wireless network 101 or at least one network node 102A/102B by association with an uplink reference signal from the UE 100.

Further, for PUCCH plane, the wireless network 101 may activate one PUCCH spatial relation information or more than one PUCCH spatial relation information for each PUCCH resource. In one embodiment, the spatial relation information(s) for each PUCCH resource is determined by the wireless network 101 or by at least one network node 102A/102B via RRC configuration or activated via 5G NR MAC CE (i.e. a control element (CE) of a media access control (MAC) layer in the 5G NR wireless communication system). Similarly, for SRS resource, the wireless network 101 may activate one SRS spatial relation information or more than one SRS spatial relation information for each SRS resource. In one embodiment, the spatial relation information(s) for each SRS resource is determined by the wireless network 101 or by at least one network node 102A/102B via RRC configuration or activated via 5G NR MAC CE.

Further, in one embodiment, the plurality of report signals are obtained from a set of acknowledgments (or negative acknowledgments) and/or CSI report(s).

In one embodiment, the transmission configurations for the spatial settings used in uplink transmissions for transmitting the report signals are associated with more than one PUCCH resources respectively, and each PUCCH resource is associated with one transmission configuration for one spatial setting and one PUCCH time-frequency resource allocation. The multiple PUCCH resources are respectively associated with different sets of PUCCH spatial relation information which can be defined as follows:

| | |
|---|---|
| “PUCCH-SpatialRelationInfo ::= | SEQUENCE { |
| pucch-SpatialRelationInfoId | PUCCH-SpatialRelationInfoId, |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| | resource |

SRS-ResourceId,

uplinkBWP

BWP-Id

| | |
|---|---|
| }, | } |
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}”;
and

| | |
|---|---|
| “CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |

reportSlotConfig

| | |
|---|---|
| CSI-ReportPeriodicityAndOffset, | SEQUENCE (SIZE |

```
        pucch-CSI-ResourceList
(1..maxNrofBWPs)) OF PUCCH-CSI-Resource
        },
  PUCCH-CSI-Resource ::= SEQUENCE {
  uplinkBandwidthPartId BWP-Id,
  pucch-Resource PUCCH-ResourceId
  }”.
```

In one embodiment, the transmission configurations for the spatial settings used in uplink transmissions for transmitting the report signals are associated with a PUCCH resource which is associated with multiple different sets of spatial relation information. The PUCCH resource is repeatedly used to transmit the report signals based on different QCL assumptions. The PUCCH resource is associated with different transmission configurations for spatial settings and different PUCCH time-frequency resource allocations.

Further, for CSI report(s), a PUCCH CSI resource list may be defined and is extended to allow two or more PUCCH resources which can be used in one bandwidth part (BWP). For example, the PUCCH CSI resource list may be added in a description of the specification of CSI report configuration. For example, two or more PUCCH CSI resource lists can be configured for CSI report configurations (“CSI-ReportConfig”). Since it may not be necessary to have two PUCCH resources supporting UL-MTRP for each BWP, a ‘null’ value should be allowed to be a candidate value for pucch-CSI-ResourceList. A corresponding description of the Radio Resource Control (RRC) structure can be described as follows:

| | |
|---|---|
| “reportConfigType | CHOICE { |
| periodic | SEQUENCE { |

reportSlotConfig
CSI-ReportPeriodicityAndOffset,

| | |
|---|---|
| pucch-CSI-ResourceList | SEQUENCE (SIZE |

(1..maxNrofBWPs)) OF PUCCH-CSI-Resource,

| | |
|---|---|
| pucch-CSI-ResourceList2 | SEQUENCE (SIZE (1..maxNrofBWPs)) |

OF PUCCH-CSI-Resource
},”

Alternatively, in other embodiments, without introducing a new resource list such as pucch-CSI-ResourceList2, two PUCCH CSI Resources with different PUCCH resource IDs in PUCCH CSI resource list can be allowed to be associated with the same BWP ID. In one embodiment, we extend the structure of CSI-ReportConfig by allowing associating a report with more than one PUCCH-CSI-Resource with the same uplinkBandwidthPartId. As a result, the number of elements in pucch-CSI-ResourceList may exceed the number maxNrofBWPs, which is the maximum number of BWPs per serving cell. Additional predefined rules may need to be specified to determine how to apply the two PUCCH resources within the same BWP for one CSI report. For example, the timing order for which PUCCH resource may be applied for the first.

Further, in one embodiment, the transmission configurations for the spatial settings used in uplink transmissions are associated with a PUCCH resource set which comprises different PUCCH resources, and each PUCCH resource is associated with one transmission configuration for one spatial setting and one PUCCH time-frequency resource allocation. That is, a PUCCH resource set may be defined and comprises two or more different PUCCH resources with different sets of spatial relation information. For example, a new parameter “pucch-resource-set-for-CSI” can be introduced and comprises more than one PUCCH resources IDs. The new field “pucch-resource-set-for-CSI” is given under CSI report configuration (“CSI-reportConfig”).

Further, in one embodiment, the transmission configurations for the spatial settings used in uplink transmissions are associated with an identical PUCCH resource which is associated with an identical PUCCH time-frequency resource allocation within a time unit (e.g., which symbols and which PRBs within in a slot are the same for the two PUCCH occasions) but with a time gap between the two PUCCH occasions.

Further, in other embodiments, the spatial relation information of PUCCH can be determined by referring to either downlink reference signal(s), channel state information reference signal(s) (CSI-RS), or uplink reference signal(s) such as SRS resource(s).

Those skilled in the art will readily observe that numerous modifications and alterations of the device and method may be made while retaining the teachings of the invention. Accordingly, the above disclosure should be construed as limited only by the metes and bounds of the appended claims.

1. A method, comprising:
transmitting a plurality of data signals via a physical uplink shared channel (PUSCH) or a plurality of report signals via a physical uplink control channel (PUCCH) from a user equipment to a wireless network according to a plurality of transmission configurations for spatial settings; and
receiving a control signal before the transmitting, by a user equipment, from the wireless network, wherein the control signal indicates the plurality of transmission configurations for the spatial settings;
wherein the plurality of transmission configurations for the spatial settings are associated with multiple reference signals.

2. The method of claim 1, wherein the multiple reference signals are two or more SRS resources.

3. The method of claim 1, wherein the plurality of data signals are transmitted on a plurality of time-frequency resources, and the plurality of time-frequency resources are not overlapped in time domain or not overlapped in frequency domain.

4. The method of claim 1, further comprising:
determining a plurality of time-frequency resources according to a plurality of PUSCH resources, a plurality of PUCCH resources, a single PUSCH resource, or a single PUCCH resource;
wherein the plurality of data signals are transmitted on the plurality of time-frequency resources;
wherein the plurality of PUSCH resources or the single PUSCH resource is used for the PUSCH; and, the plurality of PUCCH resources or the single PUCCH resource is used for the PUCCH.

5. The method of claim 1, wherein the plurality of data signals are obtained from a same raw data information and are sent from the user equipment on a plurality of time-frequency resources respectively based on the plurality of transmission configurations for the spatial settings which respectively indicate spatial filters/beams to be applied to transmit the plurality of data signals.

6. The method of claim 1, wherein the plurality of data signals are duplicated data signals.

7. The method of claim 1, wherein a transmission configuration for a spatial setting is associated with a reference signal via a sounding reference signal resource indicator (SRI) which indicates one sounding reference signal (SRS) resource , a transmission configuration indicator (TCI) state, or spatial relation information.

8. The method of claim 7, wherein a configuration of the spatial relation information is associated with a downlink reference signal from the wireless network to the user equipment or an uplink reference signal sent from the user equipment.

9. The method of claim 7, wherein the spatial relation information is assigned for each SRS/PUCCH resource via RRC configuration or activated via a media access control layer control element (MAC CE).

10. The method of claim 1, wherein the plurality of report signals are obtained from a set of acknowledgment(s) and/or channel state information (CSI) report(s).

11. The method of claim 1, the plurality of transmission configurations for the spatial settings are associated with different PUCCH resources respectively, wherein each PUCCH resource is associated with one transmission configuration for its spatial setting and one PUCCH time-frequency allocation.

12. The method of claim 1, wherein the plurality of transmission configurations for the spatial settings are associated with a PUCCH resource set which comprises different PUCCH resources; one PUCCH resource is associated with one transmission configuration for its spatial setting and one PUCCH time-frequency allocation.

13. The method of claim 1, wherein the plurality of transmission configurations for the spatial settings are associated with an identical PUCCH resource which is associated with an identical PUCCH time-frequency allocation.

14. An apparatus, comprising:
a transceiver, for wirelessly communicating with one or more network nodes of a wireless network; and
a processor, coupled to the transceiver, for:
controlling the transceiver transmitting, on a plurality of time-frequency resources, a plurality of data signals via a PUSCH or a plurality of report signals via a PUCCH from the apparatus to the wireless network according to a plurality of transmission configurations for spatial settings; and
controlling the transceiver receiving a control signal from the wireless network before transmitting the plurality of data signals, wherein the control signal indicates the plurality of transmission configurations for the spatial settings;
wherein the plurality of transmission configurations for the spatial settings are associated with multiple reference signals.

15. The apparatus of claim 14, wherein the plurality of time-frequency resources are determined according to a plurality of PUSCH resources, a plurality of PUCCH resources, a single PUSCH resource, or a single PUCCH resource; the plurality of PUSCH resources or the single PUSCH resource is used for the PUSCH; and, the plurality of PUCCH resources or the single PUCCH resource is used for the PUCCH.

16. The apparatus of claim 14, wherein the plurality of data signals are obtained from a same raw data information and are sent from the user equipment on the plurality of time-frequency resources respectively based on the plurality of transmission configurations for the spatial settings which respectively indicate spatial filters/beams to be applied to transmit the plurality of data signals.

17. The apparatus of claim 14, wherein a transmission configuration for a spatial setting is associated with a reference signal via a sounding reference signal resource indicator (SRI) which indicates one sounding reference signal (SRS) resource, a transmission configuration indicator (TCI) state, or spatial relation information.

18. The apparatus of claim 17, wherein the spatial relation information is associated with a downlink reference signal from the wireless network to the user equipment or a uplink reference signal sent from the user equipment.

19. The apparatus of claim 14, the plurality of transmission configurations for the spatial settings are associated with different PUCCH resources respectively, wherein each PUCCH resource is associated with one transmission configuration for its spatial setting and one PUCCH time-frequency allocation.

20. The apparatus of claim 14, wherein the plurality of transmission configurations for the spatial settings are associated with a PUCCH resource set which comprises different PUCCH resources or associated with an identical PUCCH resource which is associated with an identical PUCCH time-frequency allocation; wherein one PUCCH resource in the PUCCH resource set is associated with one transmission configuration for its spatial setting and one PUCCH time-frequency allocation.
